(19) United States
(12) Patent Application Publication
(10) Pub. No.: US 2022/0007625 A1
(43) Pub. Date: Jan. 13, 2022

(54) Systems and Methods for Forming a Fishing Rod

(71) Applicant: DQC International Corp., Clearwater, FL (US)

(72) Inventor: Richard Michael Teschendorf, Palm Harbor, FL (US)

(73) Assignee: DQC International Corp.

(21) Appl. No.: 16/924,175

(22) Filed: Jul. 8, 2020

(51) Int. Cl. A01K 87/00; B29C 53/56

(52) U.S. Cl. CPC A01K 87/00; B29L 2031/7002; B29C 53/566

(57) ABSTRACT

A method embodiment for forming the fishing rod can include forming a tube comprising a carbon sheet. The tube can be formed by rolling the carbon sheet around a rod template. The formed tube can comprise a proximal region and a distal region. The method can further comprise coupling an assembly. The assembly can comprise the tube and a reel seat. During coupling of the assembly, the reel seat can encompass a distal region of the tube. The assembly can be molded for structural integrity by applying heat to the assembly and allowing the assembly to cure.

### TECHNICAL FIELD

The disclosure relates generally to systems and methods for forming a fishing rod.

### BACKGROUND

As fishing technology develops, fishermen desire strong, durable, and lightweight fishing rods. In addition, fishermen also seek to have the rods possess sufficient flexibility. Traditionally, producing a rod with each of these qualities may yield conflicting results. For example, a strong and durable rod may not necessarily be flexible. In contrast, a lightweight and flexible rod may not necessarily be strong or durable. There exists a need for the rod to possess a heightened level of each of these qualities.

### SUMMARY

Some or all of the above needs and/or problems may be addressed by certain embodiments of the disclosure. Certain embodiments of the disclosure can include a method and system forming a fishing rod. A method embodiment for forming the fishing rod can include forming a tube comprising a carbon sheet. The tube can be formed by rolling the carbon sheet around a rod template. The formed tube can comprise a proximal region and a distal region. The method can further comprise coupling an assembly. The assembly can comprise the tube and a preformed reel seat. During coupling of the assembly, the reel seat can be oriented to encompass a distal region of the tube. The assembly can be molded for structural integrity by applying heat and/or pressure to the assembly and allowing the assembly to cure.

An embodiment of the fishing rod produced from the method can include a tube, wherein the tube comprises woven carbon. The tube can also comprise a distal region and a proximal region. The rod can also comprise a preformed reel seat, wherein the preformed reel seat is coupled to the distal region of the tube. Another embodiment of the fishing rod can include a tube, a preformed reel seat, and a hand grip oriented a proximal region of the tube. The preformed reel seat can be coupled to the distal region of the tube.

Other embodiments, features, and aspects of the disclosure are described in detail herein and are considered a part of the claimed disclosure. Other embodiments, features, and aspects can be understood with reference to the following detailed description, accompanying drawings and claims.

### BRIEF DESCRIPTION OF THE DRAWINGS

FIG. 1 is a top view of a fishing rod assembly for a casting rod.

FIG. 2 is a top view of a fishing rod assembly for a spinning rod.

FIG. 3A-G are diagrams depicting exemplar steps for forming a casting rod of FIG. 1.

FIG. 4A-D are diagrams depicting exemplar steps for forming a spinning rod of FIG. 2.

FIG. 5 depicts a cross-sectional side view of two layers of a rolled tube.

FIG. 6 is a flowchart that depicts method steps depicted in FIGS. 3A-G.

FIG. 7 is a flowchart that depicts method steps depicted in FIGS. 4A-D.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The following description is provided as an enabling teaching of the disclosed articles, systems, and methods in their best, currently known embodiments. To this end, those skilled in the relevant art will recognize and appreciate that many changes can be made to the various aspects of the articles, systems, and methods described herein, while still obtaining the beneficial results of the disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “a gasket” can include two or more such gaskets unless the context indicates otherwise.

As used throughout, “substantially” with respect to a measure can refer to a range of values comprising +/−10 degrees. For example, substantially orthogonal, normal, or parallel can include embodiments, where the referenced components are oriented +/−10 degrees of being classified as orthogonal, normal, or parallel, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

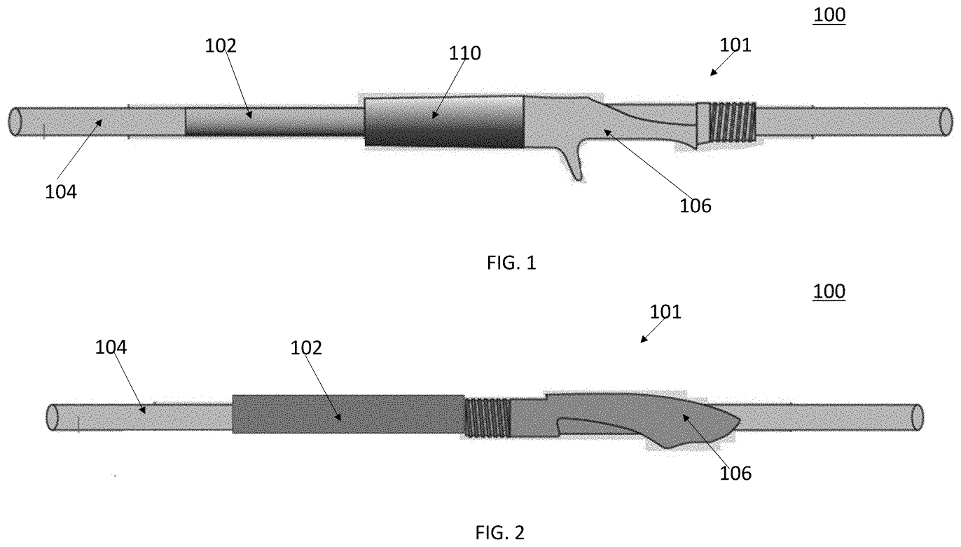

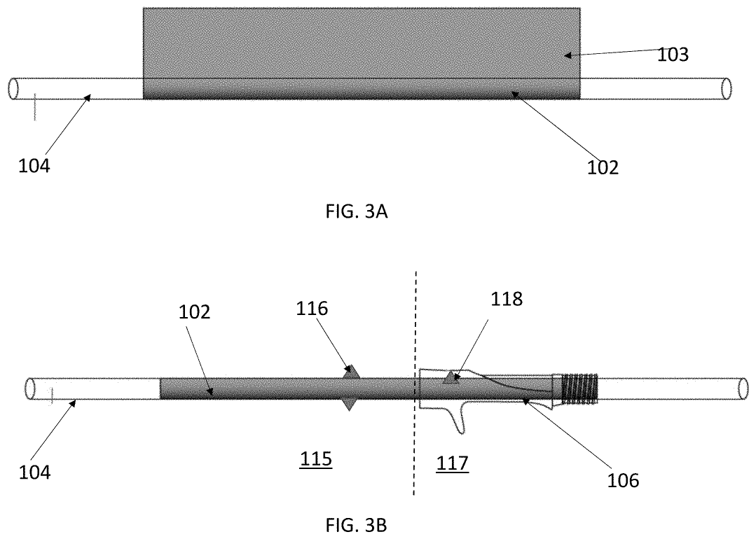

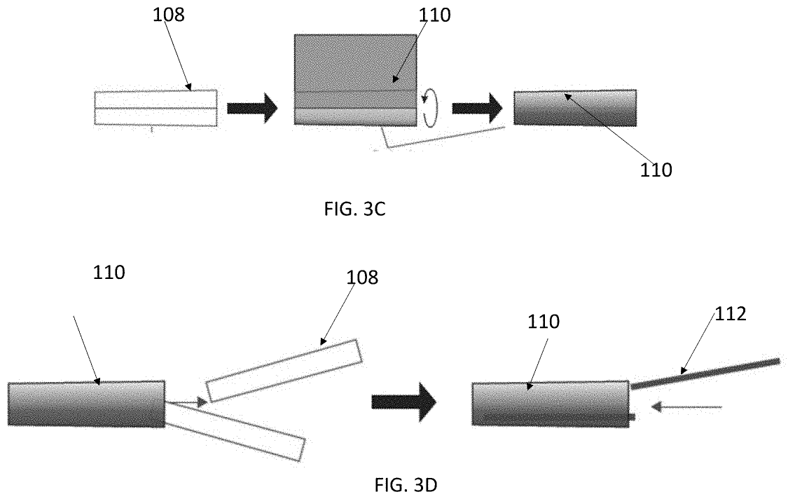

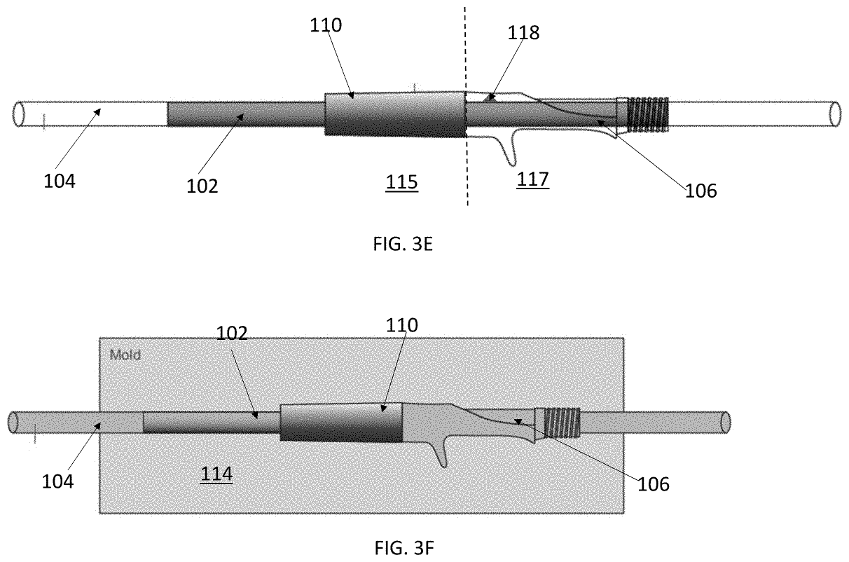

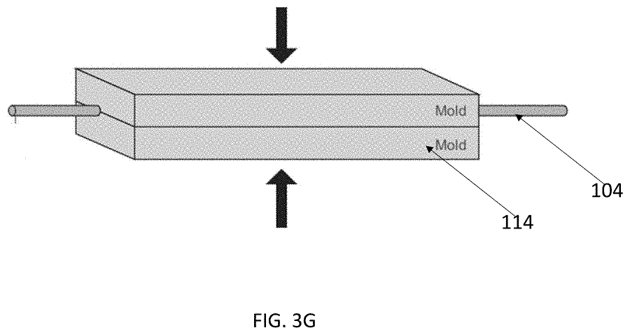

In an embodiment, the composite rod 100 can be modified for use in as a casting fishing rod or a spinning fishing rod. As shown in FIG. 1, the embodiment for the casting rod can comprise a tube 102 of woven carbon 103 coupled to a reel seat 106 and a grip 110. In a further aspect, the reel seat 106 can be preformed. As shown in FIG. 3A, the tube 102 can be formed by rolling a sheet of woven carbon 103 around a rod template 104. In one aspect, the woven carbon 103 can comprise prepreg composite fibers. In a non-limiting example, the composite fibers can be a thermoset polymer matrix material, such as epoxy, or a thermoplastic resin is already present. The fibers often take the form of a weave and the matrix is used to bond them together and to other components during manufacture.

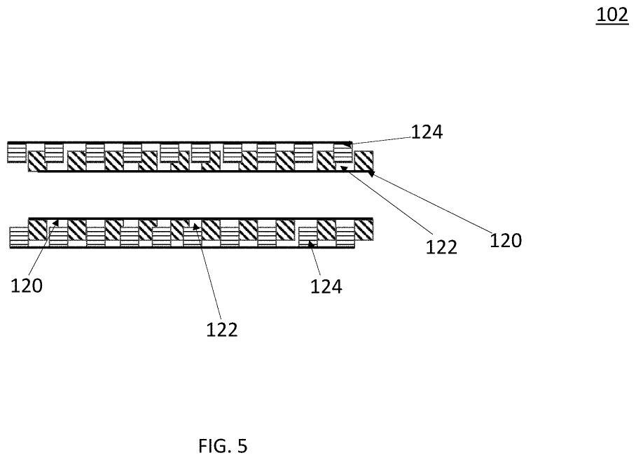

The cross-sectional area of the tube 102 can be increased by rolling additional woven carbon sheets 103 around the rod template 104. In a further aspect, adhesives can be added between rolling successive layers of carbon sheets 103. As shown in FIG. 5, a scoring pattern can be added between successive rolling iterations. In this embodiment, the abrasions 122 caused by scoring the external surface of the first layer 120 of the tube can provide an additional bonding interface between an outer surface of a first layer 120 and an inner surface of the second layer 124.

As shown in FIG. 3B, the tube 102 can comprise interface nodules 116 and 118 to increase the gripping/bonding interfaces between components of the rod assembly 101 including: the tube 102, grip 110, and reel seat 106. In a further aspect, a proximal interface nodule 116 can be oriented at a proximal region 115 of the tube 102. In another aspect, a distal interface nodule 118 can be oriented on the external surface area the tube 102 at a distal region 117 of the tube 102. The interface nodules can be place on the external surface of the tube using an adhesive. The interface nodules 116, 118 can comprise carbon, metal, plastic, or polymers, wherein the material can be adhered to the external surface and maintain structural integrity during the molding process.

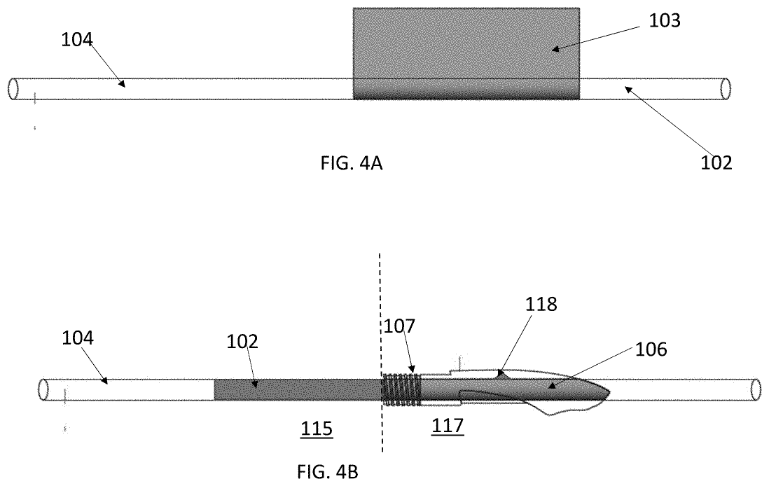

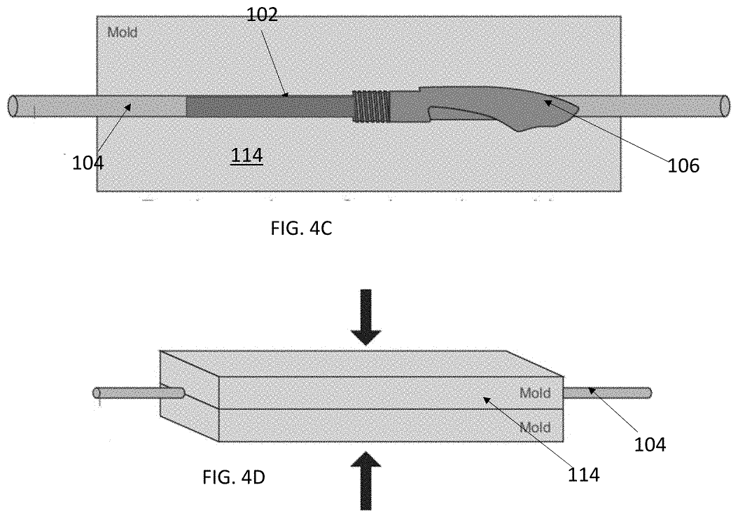

In another aspect, the interface nodules 116, 118 can be formed when the nodules are on the external surface of the rod template 104. In this case, when the woven sheets 103 are rolled over the rod template 104, the interface nodules 116, 118 will be integrated in to the external surface area of the tube 102. In yet another aspect, the interface nodules can be formed around the surface of the tube in a helical arrangement similar to a screw. During coupling, the addition components such as the grip 110 or reel seat 106 can be twisted onto the tube 102 along the helical nodule pattern 107 to increase the boding interface between the respective components of the assembly 101, as shown in FIG. 4B.

The rod assembly 101 can comprise a pre-formed reel seat 106, as shown in FIG. 3B. The preformed reel seat 106 can be coupled to a distal region 117 of the tube 102. As shown in FIG. 1 and FIG. 2 the reel seat 106 encompasses the distal portion of the tube 102.

As shown in FIGS. 3C and 3D, the rod assembly 101 can comprise a grip 110. The rod assembly 101 with the grip 110 can be implemented for the rod assembly 101 used in a casting rod. The grip 110 can be formed in a process similar to the tube 102 by rolling a woven piece of carbon around a grip template 108. The grip template 108 can be cylindrical, conical or a frustum. Additional nonlimiting examples of grip templates are possible. When the rod assembly 101 is assembled by coupling components; the grip 110 can be oriented at a proximal region 115 of the tube 102. In a further aspect, a distal end of the grip 110 can be coupled to a proximal end of the preformed reel seat 106. The grip 110 and reel seat 106 can encompass a portion of the external surface of the tube 102. In yet another aspect a different type of woven carbon 103 can be used to roll-form the grip 110. The different type of carbon sheet 103 can comprise a surface area with a textured pattern to provide additional dexterity for the user. In another aspect, a mold tooling 114 used in forming the assembly 101 can comprise a textured pattern on the tooling surface of the mold.

In an alternate embodiment, similar components can be used to form a rod assembly 101 configured for a spinning rod as shown in FIG. 2. As shown in FIGS. 1 and 2, a difference between the configurations of the spinning rod and casting rod is that the shape of the reel seat 106 is different for the two configurations. In one aspect, the spinning rod may exclude the grip 110. However, in other embodiments of the spinning rod FIG. 2 can include the grip 110.

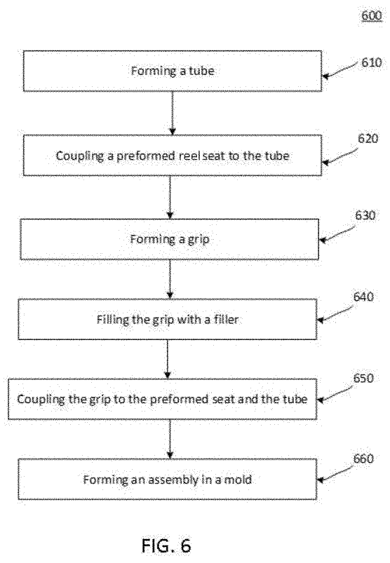

As discussed earlier, a process can be used to form the assembly for the embodiment used in the spinning rod and the embodiment for the casting rod. The flowchart in FIG. 6 depicts the steps of forming a rod as shown in FIGS. 3A-3G. The method 600 for forming a casting rod can initiate at block 610. In block 610, a tube 102 can be formed by rolling a piece of woven carbon 103 over a rod template 104. In a further aspect, multiple layers of the tube 102 can be rolled around the rod template 104 to increase the cross-sectional area of the tube 102. In another aspect, as shown in FIG. 3B, interface nodules 116, 118 can be adhered to tube 102 to help increase a coupling bond between other components of the rod assembly 101.

Method 600 can proceed to block 620. The tube 102 can be coupled to a preformed reel seat 106, as shown in FIG. 3B. The preformed reel seat 106 can be configured for coupling a casting reel to the assembly 101 for a casting rod. In aspect, the reel seat can be coupled to a distal portion of the tube 102. The bond of the tube 102 to the reel seat 106 can strengthened by the interaction between the inner surface of the preformed reel seat 106 and a distal interface nodule 118 on the surface the tube 102.

In block 630, as shown in FIG. 3C, a grip can be formed to provide additional comfort and additional manual maneuverability. Similar to the tube 102, the grip 110 can be roll-formed by rolling a sheet of woven carbon 103 over a grip template 108. As discussed earlier, the grip template 108 can used a different type of sheet, wherein the sheet comprises texturing. The texturing can be used to ease manual manipulation. In other aspects, texturing of the carbon sheet can be added to ease manual manipulation for other components of the rod assembly 101.

After the grip 110 is formed, the grip template 108 can be removed, as shown in FIG. 3D. In block 640, in the cavity left by the grip template 108, the grip 110 can be filled with a filler material 112. The filler material 112 can comprise polyurethane. The filler material 112 can also be varied depending on whether the molding process will include heat, pressure, or a combination of both. The filler material 112 can be formulated to expand upon heating and set after a curing period. The filler material 112 can further enhance the coupling bond between the components of the assembly 101. In addition, the filler material can be used to maintain the shape of the grip model.

The method 600 can proceed to block 650, wherein the components comprising the tube 102, grip 110, and the preformed reel seat 106 are coupled to form the rod assembly 101. The grip 110 can be coupled to a proximal portion of the tube 102, as shown in FIG. 3E. The bond of the tube 102 to the grip 110 can strengthened by the interaction between the inner surface of the grip 110 and at least one proximal nodule 116 on the surface the tube 102. After the rod assembly 101 is coupled, the method 600 can proceed to block 660. The rod assembly 101 can placed in a mold tooling 114, as shown in FIG. 3F. Heat can be applied to the assembly 101 to bond the components, as shown in FIG. 3G. In a further aspect, pressure on the mold tooling 114 can be applied to the assembly 101 based on applying compressive forces to the sides of the mold tooling 114. When heat is applied to the mold tooling 114, the temperature can range between 90 and 170 degrees celsuis. A preferred range may be 145 to 155 degrees celsuis. In a further aspect, pressure can be applied to mold tooling 114. When pressure is applied to the mold tooling 114, the pressure can range between 30 and 130 PSI. A preferred range may be 95 to 105 PSI. When the heat and/or pressure is applied to the mold tooling 114, the process can range between 10 and 180 minutes. A preferred range may be 10 to 30 minutes. Once the time has elapsed, the assembly 101 is removed from the mold tooling 114 and allowed to cure.

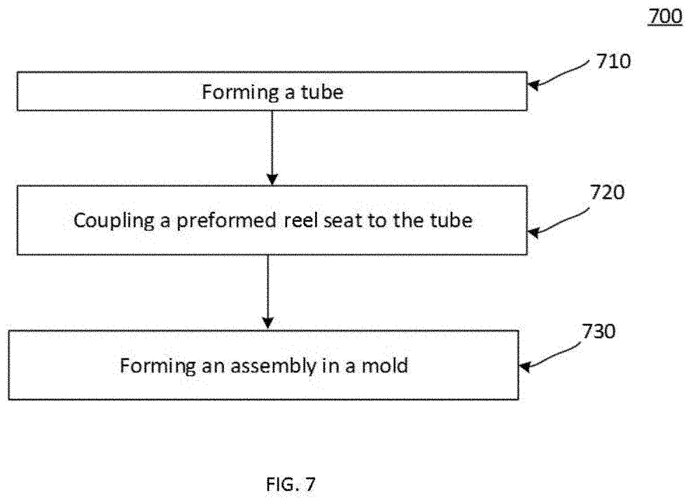

The flowchart in FIG. 7 depicts the steps of forming a rod as shown in FIGS. 4A-D. Method 700 is similar to method 600, wherein method 700 can be used to form a rod assembly for a spinning rod. The method 700 can proceed to block 710. In block 710, a tube 102 can be formed by rolling a piece of woven carbon 103 over a rod template 104, as shown in FIG. 4A. In a further aspect, multiple layers of carbon sheets 103 can be rolled around the rod template 104 to increase the cross-sectional area of the tube 102. In another aspect, nodules 116, 118 can be adhered to tube 102 to help increase a coupling bond between other components of the rod assembly 101.

Method 700 can proceed to block 720. As shown in FIG. 4B, the tube 102 can be coupled to a preformed reel seat. The preformed reel seat 106 can be configured for coupling a spinning reel to the assembly 101 for a spinning rod. In an aspect, the reel set can be coupled to a distal portion of the tube 102. The bond of the tube 102 to the reel seat 106 can strengthened by the interaction between the inner surface of the preformed reel seat 106 and a distal interface nodule 118 on the surface the tube 102.

The method 700 can proceed to block 730, wherein the components comprising the tube 102, and the preformed reel seat 106 are coupled to form the assembly 101. The assembly 101 can be placed in a mold tooling 114, as shown in FIG. 4C. In an aspect of molding the assembly, heat can be applied to the assembly 101. As shown in FIG. 4D, when heat is applied to the mold tooling 114, the temperature can range between 90 and 170 degrees celsuis. A preferred range may be 145 to 155 degrees celsuis. In a further aspect, pressure can be applied to mold tooling 114. When pressure is applied to the mold tooling 114, the pressure can range between 30 and 130 PSI. A preferred range may be 95 to 105 PSI. When the heat and/or pressure is applied to the mold tooling 114, the process can range between 10 and 180 minutes. A preferred range may be 10 to 30 minutes. Once the time has elapsed the assembly is removed from the mold tooling 114 and allowed to cure.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosure, including the best modes, and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fishing rod comprising:
a tube, wherein the tube comprises woven carbon and wherein the tube comprises a distal region and a proximal region; and
a preformed reel seat, wherein the reel seat is coupled to the distal region of the tube.

2. The fishing rod of claim 1, wherein the tube is formed by rolling the woven carbon around a rod template.

3. The fishing rod of claim 2, wherein the reel seat is preformed and configured for a spinning rod.

4. The fishing rod of claim 1, wherein the woven carbon comprises a plurality of prepreg layers.

5. The fishing rod of claim 1, wherein the distal region of the tube comprises a distal coupling nodule, wherein the distal coupling nodule is configured to interface with an inner surface of the preformed reel seat.

6. A fishing rod comprising:
a tube, wherein the tube comprises woven carbon, wherein the tube comprises a distal region and a proximal region;
a grip oriented at the proximal region of the tube; and
a preformed reel seat, wherein the preformed reel seat is coupled to the distal region of the tube.

7. The fishing rod of claim 6, wherein the tube is formed by rolling the woven carbon around a rod template.

8. The fishing rod of claim 7, wherein the reel seat is configured for a casting rod.

9. The fishing rod of claim 7, wherein the woven carbon comprises a plurality of prepreg layers.

10. The fishing rod of claim 7, wherein the grip is formed by rolling woven carbon around a grip model and a shape of the grip is maintained by a filler material.

11. The fishing rod of claim 7, wherein the grip comprises woven carbon that comprises a textured pattern on an external surface of the tube.

12. The fishing rod of claim 10, wherein the proximal region of the tube comprises a proximal coupling nodule, wherein the proximal coupling nodule is configured to interface with the filler material.

13. The fishing rod of claim 7, wherein the distal region of the tube comprises a distal coupling nodule, wherein the distal coupling nodule is configured to interface with an inner surface of the preformed reel seat.

14. A method of forming a composite fishing rod comprising:
forming a tube comprising a carbon sheet, by rolling the carbon sheet around a rod template, wherein the tube comprises a proximal region and a distal region;
coupling an assembly comprising the tube and a reel seat, wherein the reel seat encompasses a distal region of the tube; and
applying heat to the assembly.

15. The method of claim 14, further comprising applying pressure to the assembly.

16. The method of claim 14, further comprising forming a grip comprising a woven carbon sheet, by rolling the carbon sheet around a grip template, wherein the grip comprises a proximal end and a distal end.

17. The method of claim 16, further comprising filling the grip with a filler material.

18. The method of claim 16, further comprising coupling the grip to the assembly by orienting the distal end of the grip to a proximal region of the tube.

19. The method of claim 18, wherein the proximal region of the tube comprises a proximal coupling nodule, wherein the proximal coupling nodule extends away from an external surface of the tube surface and couples to an interior surface of the grip.

20. The method of claim 14, wherein the distal region of the tube comprises a distal coupling nodule, wherein the distal coupling nodule is configured to interface with an inner surface of the preformed reel seat.
